(19) United States
(12) Patent Application Publication
(10) Pub. No.: US 2015/0099447 A1
(43) Pub. Date: Apr. 9, 2015

(54) HEAT REMOVAL APPARATUS AND A METHOD OF REMOVING HEAT

(71) Applicant: Matthew Joo How OH, Pyrmont (AU)

(72) Inventor: Matthew Joo How OH, Pyrmont (AU)

(21) Appl. No.: 14/048,055

(22) Filed: Oct. 8, 2013

(51) Int. Cl. G06F 1/20; G06F 1/18

(52) U.S. Cl. CPC G06F 1/20; G06F 1/182
USPC 454/184; 361/679.46

(57) ABSTRACT

Disclosed is a heat removal apparatus to be used in conjunction with a case of a computer processing unit. The apparatus comprises an air permeable cover disposed over a top opening of the case, the air permeable cover for enabling the hot air in the case to egress therethrough and a cap secured over the air permeable cover for preventing dust and liquids from entering the case therethrough while allowing the passage of hot air therethrough by virtue of the stack effect.

### CROSS-REFERENCE TO RELATED APPLICATION

This application claims benefit of priority of U.S. provisional Application No. 61/711,621, filed on Oct. 9,2012 ; entitled “A HEAT REMOVAL APPARATUS AND A METHOD OF REMOVING HEAT”, owned by the assignee of the present application and herein incorporated by references in its entirety.

### TECHNICAL FIELD

The disclosure herein generally relates to a heat removal apparatus and a method of removing heat, and specifically but not exclusively to a heat removal apparatus and a method of removing heat having consumer appeal.

### BACKGROUND

Processing units, for example a computing device's CPU, motherboard, graphics accelerators, and their peripherals, generate heat. This heat must be removed from the processing unit case for reliable long-term operation of the processing units.

A personal computer may be modified to operate faster than specified by the manufacturer. Speed enhancing modifications may include increasing the clock frequency (“overclocking”), changing the CPU multiplier, changing memory timing, and changing an operating voltage.

These changes may increase power consumption by the processing unit, generating more heat that must be removed. Without adequate heat removal, some digital circuits will slow down or even fail.

Powerful fans, larger heat sinks, heat pipes and water cooling may remove the generated heat. There is a need to cool processing units using an arrangement and in a manner that is effective and attractive to consumers, especially to those that may wish to modify their personal computers.

### SUMMARY

Disclosed herein is a heat removal apparatus. The apparatus comprises at least one wall arranged to be disposed around the perimeter of an opening in a case for a processing unit. The apparatus comprises an air permeable cover arranged to be disposed over the opening and arranged to cooperate with the at least one wall to block at least one of radio wave and microwaves that egress the case through the opening. The apparatus comprises an adjustable cap supporting structure arranged to support a cap over the air permeable cover at an adjustable separation from the air permeable cover.

Examples of processing units include but are not limited to a central processing unit, a motherboard, a graphics accelerator, and their peripherals.

Generally, but not necessarily, the at least one wall constitutes a stack. Air made buoyant by heat from a processing unit that may be disposed in the case may be driven through the stack by the stack effect, providing an optional completely passive means for removing heated air from the case. The air permeable cover may provide egress of the heated air while blocking the at least one of radio waves and microwaves that may be generated by the processing unit. The air permeable cover may also block objects moving into the case that may damage the processing unit. The air permeable cover may, however, be permeable to a liquid and may not prevent the inadvertent flow of a liquid into the case. The cap when so supported may provide a barrier for a liquid such as a beverage being consumed by a person near the case. Consequently, an embodiment may provide a relatively quiet heat removal apparatus which may not require a fan, and which may prevent the ingress of objects and liquids into the case. The adjustable supporting structure provides great flexibility on choice of cap. A consumer may wish the cap to conform to their preference. For example, a consumer may wish to use a body of a model car as a cap. Different model cars have different shapes and so require to be held at a different separation from the air permeable cover. Another consumer may wish to use a sculpture as a cap, for example. Generally the heat removal apparatus may accommodate a wide range of consumer selected caps.

In an embodiment the cap when so supported conceals the at least one wall and air permeable cover. A consumer may not wish to have the relatively unappealing at least one wall and air permeable mesh exposed and may wish to conceal them with the cap.

In an embodiment, the air permeable cover comprises a mesh arranged to block the at least one of radio waves and microwaves. The at least one wall may be arranged to block the at least one of radio waves and microwaves. A mesh may have relatively very good airflow properties while still blocking the at least one of radio waves and microwaves.

In an embodiment, the at least one wall and the air permeable cover define a heat exchanger receiving space for receiving a heat exchanger thermally coupled to the processing unit. A water cooled block may be in thermal contact with the processing unit. The heat exchanger may be in water communication with the water cooled block. Water moved through the water cooled block may move through the heat exchanger and so be cooled before being returned to the water cooled block. The air permeable cover may be arranged to attach to the heat exchanger. The air permeable cover may have a plurality of fastener receiving apertures having the same relative disposition as that of a plurality of fastener receiving apertures of the heat exchanger. A plurality of fasteners may be received by the fastener receiving apertures of the air permeable cover, and also may be received by fastener receiving apertures of the heat exchanger. An embodiment and the heat exchanger may be attached by any suitable means including but not limited to screws, adhesive, rivets, and clips.

In an embodiment, the plurality of fastener receiving apertures of the air permeable cover also have the same relative disposition as that of a plurality of fastener receiving apertures of a fan. The fan may be fixed to the air permeable cover by fasteners that are received by the plurality fastener receiving apertures of the air permeable cover and the plurality of fastener receiving apertures of the heat exchanger.

In an embodiment, the adjustable cap supporting structure comprises a carriage. The carriage may be have slots through which fasteners that are fixed to the at least one wall pass.

Alternatively or additionally, the carriage may be movable along a slot formed in the at least one wall. The carriage may be arranged to be fixed to the cap. There may be a plurality of carriages.

An embodiment comprises a skirt. The skirt may have apertures formed therein for receiving fasteners. The fasteners may secure the embodiment to the case. The heat removal apparatus may be retrofitted to the case. Alternatively, the heat removal apparatus may be integral with the case.

In an embodiment the at least one wall has at least one air flow intake formed therein.

In an embodiment, the cap is a decorative cap. The at least one wall may have at least one aperture formed therein for attaching at least one decorative item to the at least one wall.

Disclosed herein is a case for a processing unit having a heat removal apparatus attached thereto in accordance with the above disclosure.

Disclosed herein is a method of removing heat. The method comprising the step of disposing at least one wall around a perimeter of an opening in a case housing a processing unit. The method comprises the step of disposing an air permeable cover over the opening. The method comprises the step of blocking at least one of radio waves and microwaves traveling through the opening with the at least one wall and the air permeable cover. The method comprises the step of adjusting the separation of a cap over the air permeable cover.

An embodiment comprises the step of using a stack effect to move air through the opening and the air permeable cover.

An embodiment comprises the step of disposing a heat exchanger thermally coupled to the processing unit in a heat exchanger receiving space defined by the at least one wall and the air permeable cover. A fan may be used to move air through the opening and the air permeable cover.

In an embodiment, the cap is a decorative cap. The method may comprise the step of attaching at least one decorative item to the at least one wall.

In an embodiment, the step of adjusting the separation conceals the at least one wall and air permeable cover with the cap.

Any of the various features of each of the above disclosures, and of the various features of the embodiments described below, can be combined as suitable and desired.

### BRIEF DESCRIPTION OF THE FIGURES

Embodiments will now be described by way of example only with reference to the accompanying figures in which:

FIG. 1 shows a perspective view of one embodiment of a heat removal apparatus.

FIG. 2 shows a plan view of the embodiment of the heat removal apparatus of FIG. 1.

FIG. 3 shows another perspective view of the embodiment of the heat removal apparatus of FIG. 1.

FIG. 4 shows an exploded perspective view of the embodiment of the heat removal apparatus of FIG. 1.

FIG. 5 shows a perspective view of another embodiment of a heat removal apparatus revealing a heat exchanger receiving space.

FIG. 6 shows an exploded perspective view of a computing assembly including the embodiment of the heat removal apparatus of FIG. 1.

FIG. 7 shows another perspective view of the embodiment of a heat removal apparatus of FIG. 5.

FIGS. 8 and 9 show different perspective views of the embodiment of a heat removal apparatus of FIG. 5 having fixed thereto an optional airflow molding.

FIG. 10 shows a perspective view of another embodiment of a heat removal apparatus and a cap in the form of a model car body to be receiving thereby.

FIGS. 11 and 12 show perspective views of a method of attaching an example cap to the eat removal apparatus of FIG. 1.

FIG. 13 shows the heat removal apparatus with the suction fan

### DESCRIPTION OF EMBODIMENTS

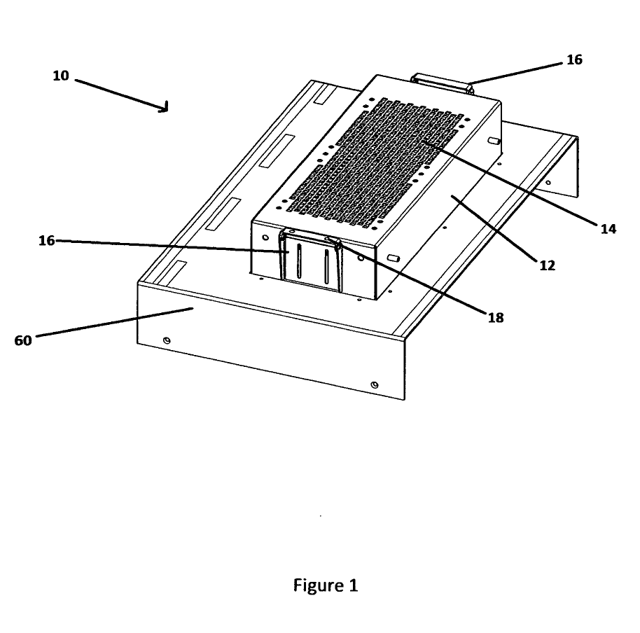

FIG. 1 shows a perspective view of one embodiment of a heat removal apparatus, generally indicated by the numeral 10. The apparatus 10 has a wall 12 that is arranged to be disposed around the perimeter of an opening in a case for a processing unit, for example a personal computer case. The wall 12 of the embodiment of FIG. 1 has four wall sections arranged to form a rectangle, however the four sections may have generally any configuration. The wall may form a circle, or any suitable shape. Attached to the top of the wall 12 is an air permeable cover in the form of a mesh panel 14. The mesh panel 14 has a plurality of apertures through which air may flow. The opening may be formed in a topmost surface of the case and the heat removal apparatus may be disposed above the opening. Buoyant air heated by the processing unit within the case may be drawn through the opening and through the air permeable cover 14. Alternatively, air may be forced (by use of a fan, for example) through the opening and the mesh panel such that the heated air in the case is displaced. The mesh panel 14 is arranged to block to at least one of radio waves and microwaves that are generated by the processing unit.

Consequently, the power of any interfering electromagnetic radiation released into the surroundings may be substantially reduced, in some embodiments to a negligible power. The mesh panel has a plurality of apertures each in the form of holes through the panel measuring between 1 and 10 mm In this embodiment, they are circular and holes have a diameter of between 5 and 6 mm, specifically 4 mm. Alternatively, the holes may be hexagonal or any other suitable shape.

The movement of the air may be enhanced by a stack effect when the at least one wall forms a stack as shown in FIG. 1, for example. Not all embodiments comprise a stack, however. In this but not necessarily all embodiments have at least one fan lower in the case that may enhance the stack effect by drawing cool air into the lower portion of the case therefore assisting the movement of hot air out through the air permeable cover.

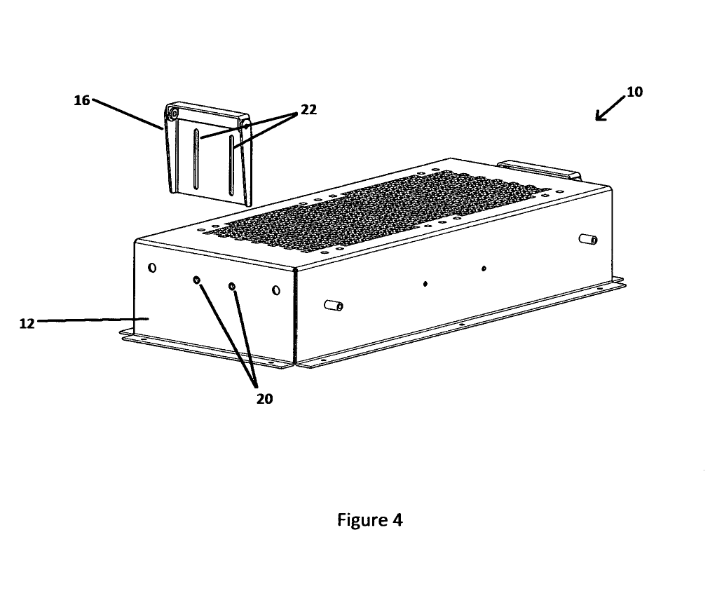

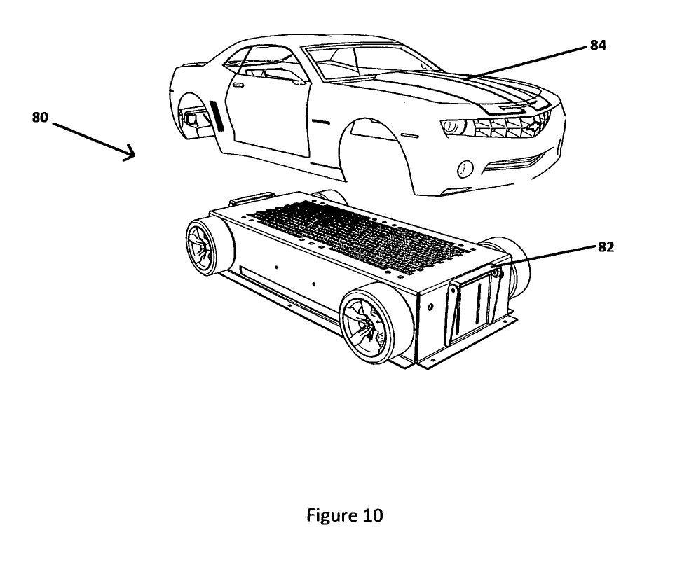

The heat removal apparatus 10 has an adjustable cap supporting structure in the form of two carriages 16 attached to respective opposite wall sections of the wall 12. As shown in FIG. 4, for example, the carriages 16 each comprise a bracket in the form of a right angled bracket that may be moved with respect to the at least one wall. Some embodiments, for example the embodiment 80 of FIG. 10, may have bracket 82 with an angle other than 90 degrees, for example less than 90 degrees, to accommodate a sloping surface of a cap 84 when so supported. Returning to FIG. 4, the carriage has guiding edges that define fastener receiving slots 22 through which fasteners in the form of screws, rivets or other suitable fasteners, may pass. The fasteners may be fixed to the at least one wall. Integrated into the at least one wall may be two threads provided by self-clinching nuts 20. The self-clinching nuts 20 engage with threads formed on the fasteners. The position of the carriage 16 relative to the at least one wall may then be set by loosening the fasteners, moving the carriage to the desired position, and then re-tightening the screw. The guiding edges and the fasteners cooperate to guide the movement of the carriages to simplify cap placement.

In an alternative embodiment that is not illustrated, each bracket has attachment lugs in the form of internally threaded projecting tubes. The internal threads are for engaging with fasteners in the form of screws. A screw may pass through the cap and be received by an internal thread for fastening the cap to a carriage. Any alternative fastening means, for example rivets or adhesive, may be used as suitable. The carriage may be movable along slots formed in the at least one wall 12. A projecting tube may be attached to the carriage and may have an internal thread for a screw which is passed from the interior of the heat removal apparatus, through the slot and into the tube to engage the internal thread. The position of the carriage relative to the wall may then be set by loosening the screw, moving the carriage along the slot to the desired position, and then re-tightening the screw. In this embodiment, each carriage has two threaded tubes, each tube being for receiving a screw that passes through one of the slots. Other embodiments may have more or less tubes and slots as suitable.

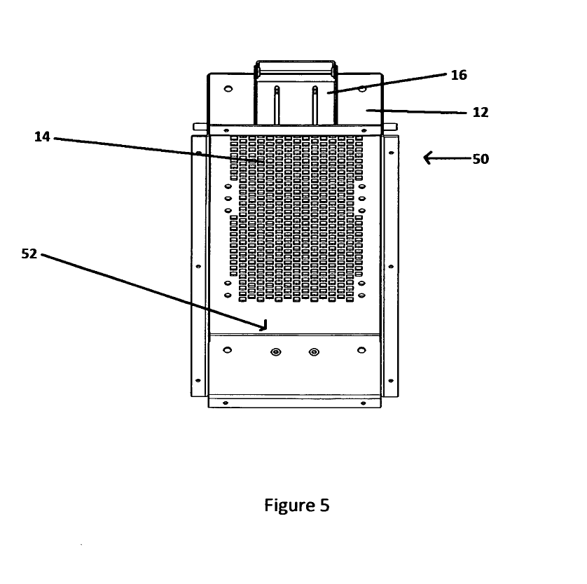

FIG. 5 shows a perspective view of another embodiment of a heat removal apparatus 50 that is similar to that of FIG. 1, where parts similar or identical in form or function are similarly numbered. The at least one wall 12 and the air permeable cover 14 define a heat exchanger receiving space 52 for receiving a heat exchanger 54 thermally coupled to the processing unit. In this embodiment, the heat exchanger is in the form of a radiator. The heat exchanger may be a shell and tube, plate heat, or any other suitable heat exchanger. A water cooled block may be in thermal contact with the processing unit. Water moved through the water cooled block may be communicated through fluid conduits in the form of pipes to the heat exchanger, moved through the heat exchanger 54 and so be cooled, and then returning to the water cooled block. The air moving within the at least one wall 12 may cool the heat exchanger. The air heated by the heat exchanger may be buoyant, driving a stack effect.

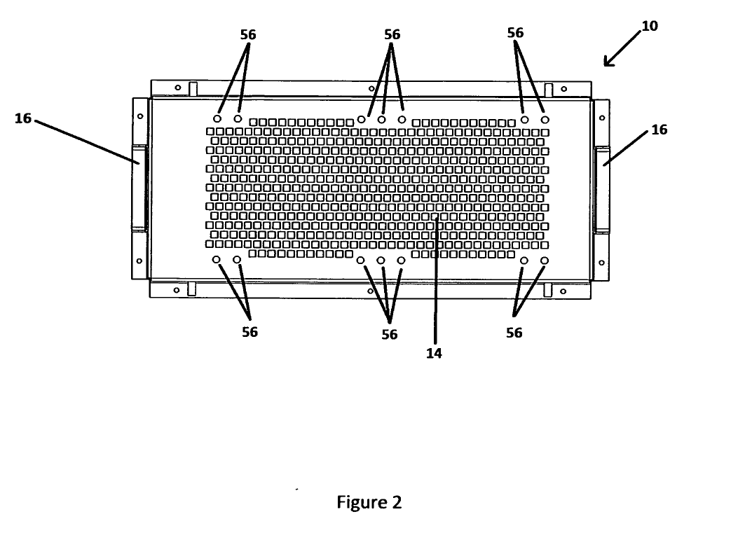

The air permeable cover 14 may be arranged to attach to the heat exchanger. The air permeable cover may have a plurality of fastener receiving apertures 56 (labeled in FIG. 2) having the same relative disposition as that of a plurality of fastener receiving apertures of the heat exchanger. The fastener receiving apertures 56 of the air permeable cover 14 may receive a plurality of fasteners. A plurality of fastener receiving apertures (which may be threaded) of the heat exchanger may also receive the plurality of fasteners. The air permeable cover 14 and the heat exchanger 54 may be attached by any suitable means including but not limited to screws, adhesive, rivets, and clips.

The plurality of fastener receiving apertures 56 of the air permeable cover 14 also have the same relative disposition as that of a plurality of fastener receiving apertures of two fans 58 placed side by side. The fans may be fixed to the air permeable cover 14 by fasteners that are received by the fastener receiving apertures of the air permeable cover 14 and the fastener receiving apertures of the heat exchanger 54.

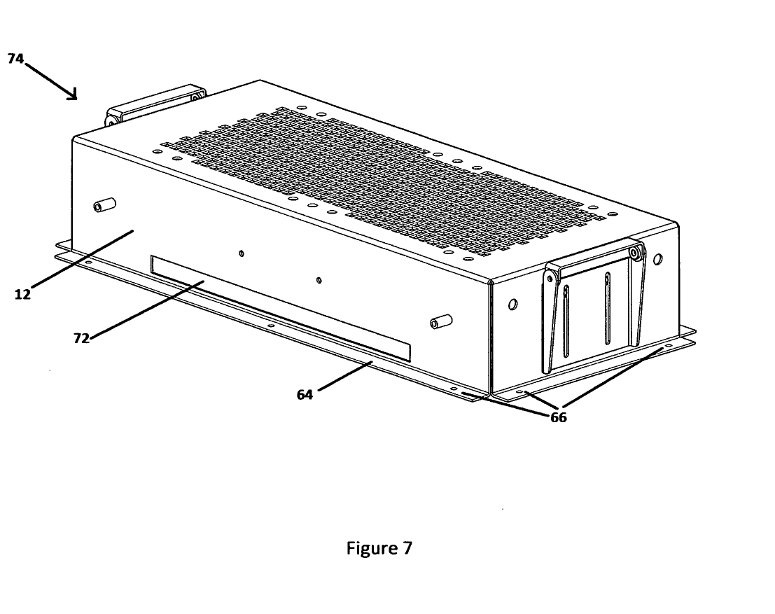

The embodiment shown in FIG. 1 is integral with the case, specifically a removable cover 60 of the case 62. The embodiment shown in FIGS. 5, 7 and 8, for example, are not integral with the case. FIG. 7 shows this embodiment 74 having a skirt 64 in the form of a perimeter bracket or flange having apertures 66 formed at each corner therein for receiving case attaching fasteners. The skirt may additionally or alternatively be attached by adhesive or any other suitable means.

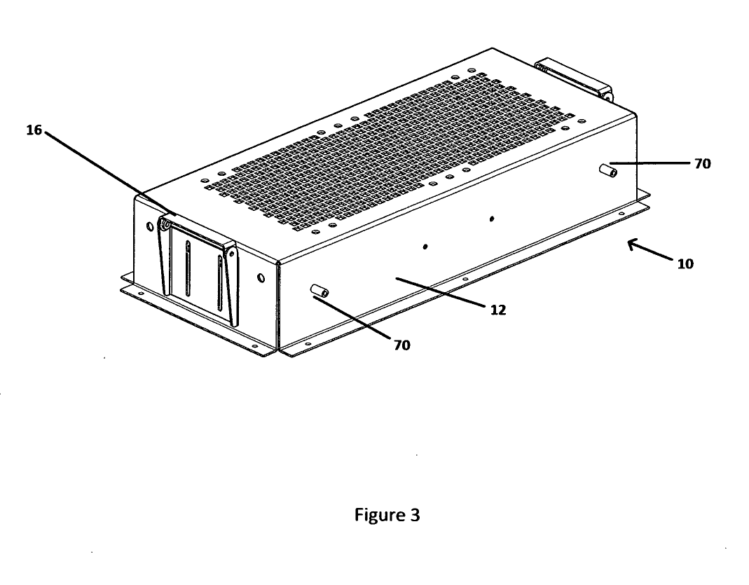

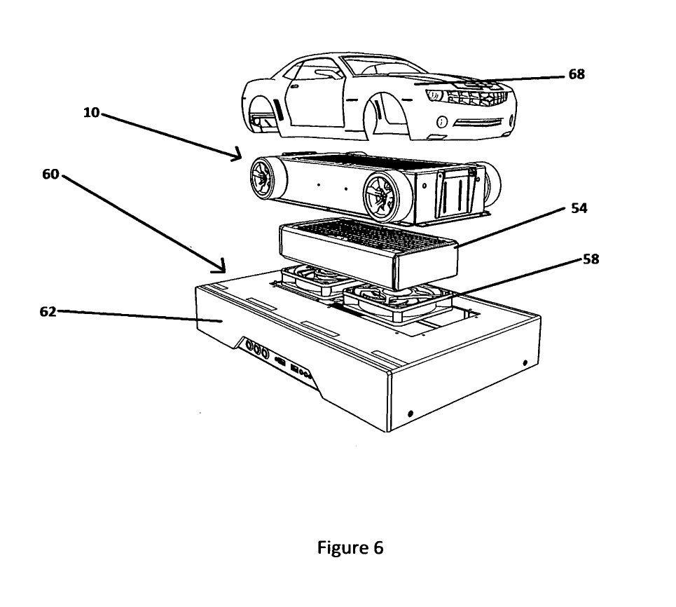

FIG. 6 shows an exploded perspective view of a computing assembly including the heat removal apparatus 10 of FIG. 1, fans 58, heat exchanger 54, and a cap 68. The cap 68 is a decorative cap in the form of a body of a model car. The body may have apertures formed therein for the passing of a shank of a fastener that is engaged by a thread of the carriage 18 which is part of a self-clinching fastener integrated with the carriage. The head of the fastener may bear against an upward facing surface of the model car body. The model car body has an internal cavity in which the at least one wall and air permeable panel may be concealed to improve consumer acceptance. The model car body also provides a physical barrier to liquids protecting the processing unit from accidental spills, for example, and is a protective barrier for the heat exchanger and/or fluid conduits. Decorative items in the form of model car wheels are attached to the at least one wall 12. Fasteners in the form of screws pass through apertures 70 (labeled in FIG. 3) formed in the at least one wall 12 to fix the wheels to the at least one wall. The wheels may alternatively or additionally be attached with adhesive or any suitable means.

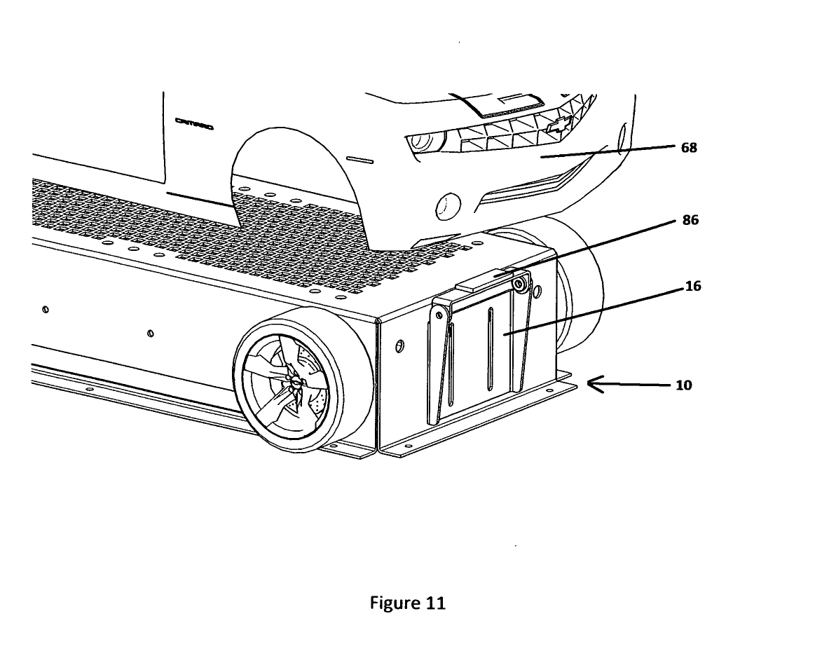

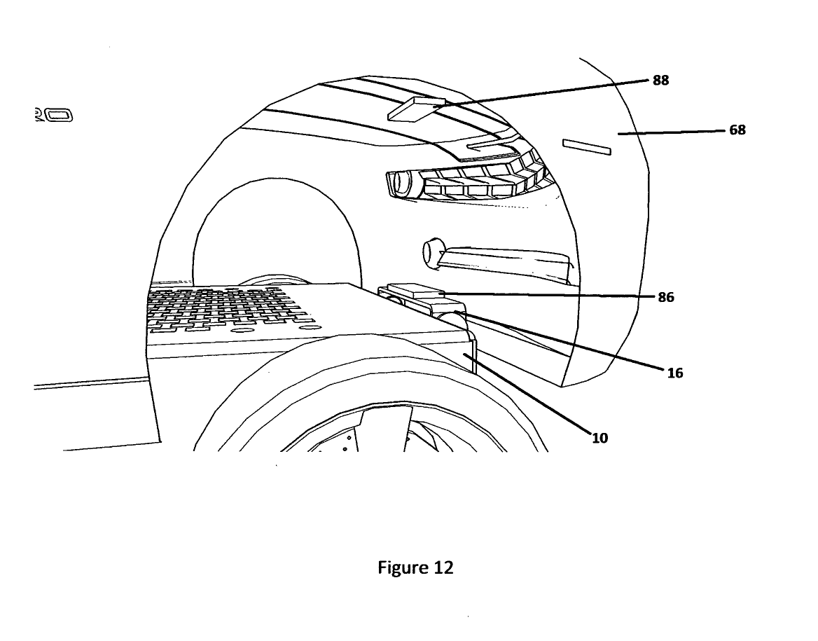

FIGS. 11 and 12 show an alternative method of attaching the cap 68 to the heat removal apparatus 10. A piece of adhesive backed hook and loop (Velcro) strip 86 is adhered to the top surface of the carriage 16. This piece 86 will be either hook or loop. The counterpart 88 of the hook or loop strip 86 is attached to the underside of the cap 68. When the cap 68 is lowered the hook and loop contact and form a bond. If the gap is too wide to enable the bond the carriage is adjusted vertically up. This solution may not require any holes to be made in the cap 68 and may improve aesthetics and ease of removal of the cap while still securing it.

The at least one wall 12 of the embodiments of FIGS. 5, 7 and 8 also have at least one air flow aperture 72 formed therein for extra ventilation. This may be especially useful to introduce cool air between the at least one wall to cool the heat exchanger cooler used.

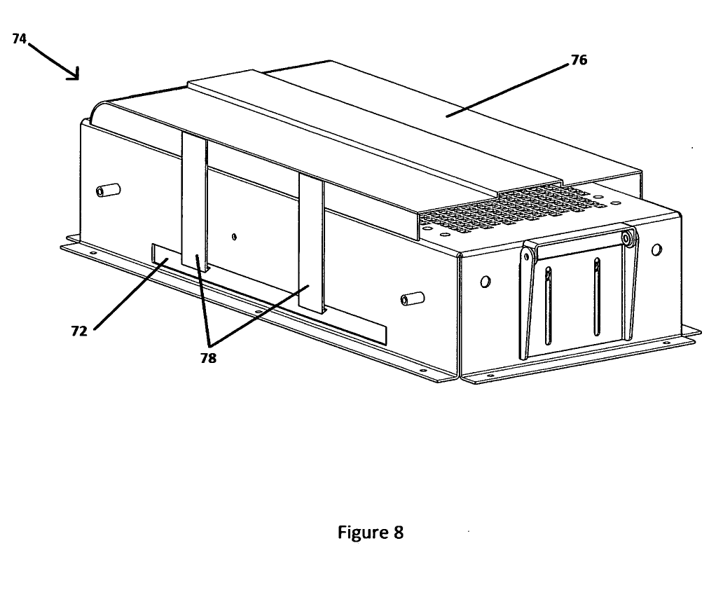

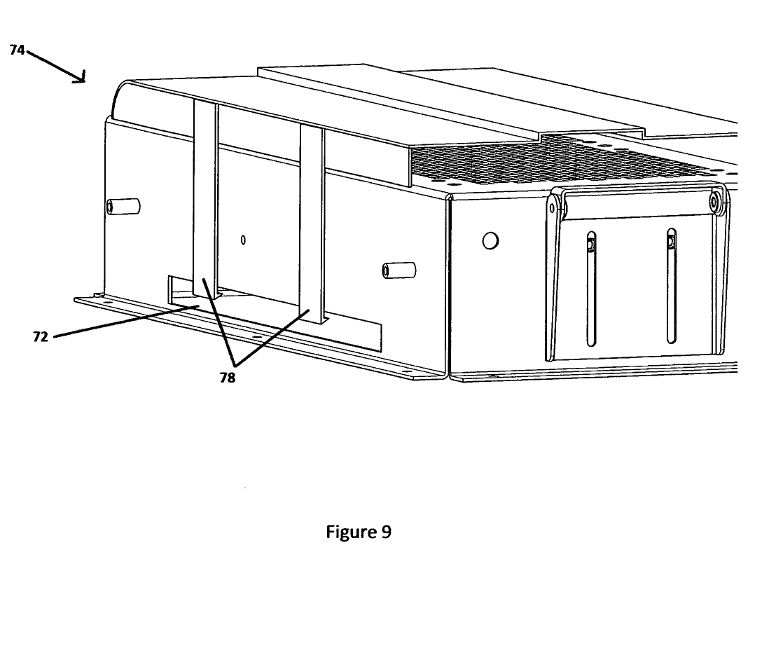

FIGS. 8 and 9 show different perspective views of the heat removal apparatus 74 of FIG. 7 having fixed thereto an optional airflow molding 76. The molding has tabs 78 having distal hooks that fix the molding to the apparatus 74. A user may pull the tabs 78 back to release the molding from the apparatus 74. Cool air may be drawn through the air intake 72, past the heat exchanger drawing away heat, and the heated exhaust air directed out on a side of the apparatus 74 not having an air intake 73, away from the intake ventilation slots 72. Consequently, there is relatively little exhaust air that enters the intake 73. Exhaust air that enters the intake 73 may reduce cooling efficiency.

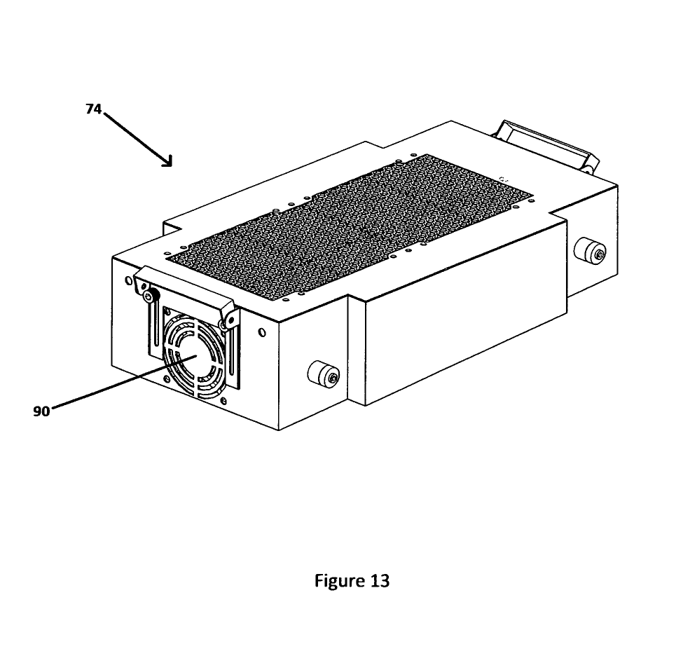

Referring to FIG. 13, in one embodiment, a wall of the heat removal apparatus 74 is fitted with a suction fan 90 for evacuating the hot air emanated from within the case.

Now that embodiments have been described, it will be appreciated that some embodiments may have some of the following advantages:
Effective cooling may be achieved with low noise generation, especially when a stack effect is used to draw air through the case. The noise generated by fans may be distracting to computing users, examples of which include but are not limited to computer garners and persons using a home theater personal computer (HTPC).
A barrier against objects and liquids entering a case may be provided.
A decorative cap of the consumer's choice may be used to adorn a case and conceal the at least one wall and air permeable cap, increasing consumer appeal.

Variations and/or modifications may be made to the embodiments described without departing from the spirit or ambit of the invention. The present embodiments are, therefore, to be considered in all respects as illustrative and not restrictive.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

What is claimed is:

1. A heat removal apparatus comprising:
(a) an air permeable cover disposed over a top opening of a case of a computer processing unit, the air permeable cover for enabling the air carrying the heat emanating from the computer components in the case to egress therethrough; and
(b) a cap secured over the air permeable cover, the cap for preventing dust and liquids from entering into the case therethrough, while allowing the passage of hot air therethrough by virtue of the stack effect.

2. The apparatus of claim 1 wherein, the cap is removably secured over the air permeable cover.

3. The apparatus of claim 1 wherein, the distance between the air permeable cover and the cap is adjustable.

4. The apparatus of claim 1 further comprising at least one wall extending downwardly from edges of the air permeable cover forming a bottom-open enclosure between the at least one wall and the air permeable cover; the bottom edge or edges of the at least one wall secured to the case that surrounds the opening.

5. The apparatus of claim 4 wherein, the enclosure is adapted to receive a heat exchanger therewithin, the heat exchanger for removing the heat emanated from the computer components within the case.

6. The apparatus of claim 4 wherein, the enclosure is adapted to receive one or more suction fans therewithin, the fan for removing the heat emanated from the computer components within the case.

7. The apparatus of claim 4 wherein, the at least one wall comprises four rectangular walls integrally connected about the lateral edges thereof so as to form a rectangular structure.

8. The apparatus of claim 4 further comprising a pair of carriages opposingly disposed on the exterior surface of the at least one wall, each carriage configured to be movable between downward and upward extremity positions, the cap secured to the carriage whereby the cap to vertically movable as the carriages are movable.

9. The apparatus of claim 8 wherein, the cap is structurally configured to conceal the top portion of the at least one wall when the carriages are at the upward extremity position.

10. The apparatus of claim 8 wherein, the cap is structurally configured to conceal the entirety of the at least one wall when the carriages are at the downward extremity position.

11. The apparatus of claim 1 wherein, the air permeable cover comprises a horizontal rectangular panel comprising a mesh for enabling fluid communication therethrough.

12. The apparatus of claim 1 wherein, the at least one wall comprises at least one air intake formed therein.

13. The apparatus of claim 1 wherein, the at least one wall comprises at least one suction fan fitted thereinto.

14. The apparatus of claim 1 being integral with the case.

15. A heat removal apparatus comprising:
(a) a plurality of laterally connected walls connected to a case of a computer processing unit about the bottom edges thereof such that, a top opening of the case is encompassed by the plurality of walls;
(b) an air permeable cover sealingly secured to the top edges of the plurality of walls, the air permeable cover for enabling the hot air emanated from the computer components within the case to egress therethrough by virtue of the stack effect; and
(c) a cap removably secured over the air permeable cover, the cap for preventing dust and liquids from entering the case therethrough while allowing the passage of hot air therethrough; the distance between the cap and the air permeable cover configured to be adjustable.
